(19) United States
(12) Patent Application Publication
(10) Pub. No.: US 2008/0067398 A1
(43) Pub. Date: Mar. 20, 2008

(54) Analyzing electromagnet

(75) Inventor: Shojiro Dohi, Kyoto (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: NISSIN ION EQUIPMENT CO., LTD.

(21) Appl. No.: 11/808,342

(22) Filed: Jun. 8, 2007

(30) Foreign Application Priority Data
Jun. 9, 2006 (JP) P.2006-160991

(51) Int. Cl. H01J 1/50

(52) U.S. Cl. 250/396 ML

(57) ABSTRACT

In an analyzing electromagnet 40, each of magnetic poles 80 in which the plan-view shape is curved is divided along the traveling direction of an ion beam 2 into three partial magnetic poles 81 to 83. The gaps of the first and third partial magnetic pole pairs 81, 83 as counted from the inlet for the ion beam 2 are widened toward the outside of the curvature, and the gap of the second partial magnetic pole pair 82 is widened toward the inside of the curvature.

This application claims priority to Japanese Patent Application No. 2006-160991, filed Jun. 9, 2006, in the Japanese Patent Office. The priority application is incorporated by reference in its entirety.

### TECHNICAL FIELD

The present disclosure relates to an analyzing electromagnet which is to be used in an ion implanting apparatus, an ion doping (registered trademark) apparatus, or the like, and which deflects an ion beam to perform momentum analysis (for example, mass analysis) of the ion beam, and more specifically to an analyzing electromagnet which analyzes the momentum of a ribbon-like ion beam.

### RELATED ART

For example, Patent Reference 1 (UM-A-64-7753 (FIG. 1)) discloses an example of a related-art analyzing electromagnet which deflects an ion beam to perform momentum analysis (for example, mass analysis, and the same shall apply hereinafter) of the ion beam.

FIG. 11 shows an example in which, in such a related-art analyzing electromagnet, an ion beam 2 having a ribbon like (this is called also a sheet-like or a strip-like) shape in which, as shown in, for example, shown in FIG. 15, the dimension W_{y} in the y direction in a plane intersecting with the traveling direction z is larger than the dimension Wₓ in the x direction perpendicular to the y direction is incident between magnetic poles in which the plan-view shape is curved, and which are opposed to each other through a gap in the y direction. FIG. 11 shows in the vicinity of an inlet for the ion beam 2.

The analyzing electromagnet 4 comprises a core 6 having an H-like section shape. The core 6 has: a pair of upper and lower magnetic poles 8 which are opposed to each other through a gap 12 in the y direction; and a yoke 10 which connects the magnetic poles 8 together. The plan-view shape of each of the magnetic poles 8 is curved into a sector shape. The opposing faces 9 of the magnetic poles 8 are parallel to each other. A coil 14 is wound around a root portion of each magnetic pole 8. In this example, a magnetic field is upward generated. The magnetic field is diagrammatically indicated by several magnetic force lines 16 (the same shall apply to other figures).

The ion beam 2 has a ribbon-like shape. However, the ribbon-like shape does not mean a shape in which the dimension Wₓ in the x direction is paper-thin. For example, the dimension W_{y} in the y direction of the ion beam 2 is about 400 to 900 mm, and the dimension Wₓ in the x direction is about 30 to 100 mm.

The ion beam 2 having the above-described shape is incident between the upper and lower magnetic poles 8, i.e., on the gap 12. During travel, then, the ion beam 2 is subjected to a Lorentz force which is rightward as viewed in the traveling direction z, to be rightward deflected, thereby analyzing the momentum. In this specification, the case where the ion beam 2 is configured by positive ions will be exemplarily described.

In the case where the ribbon-like ion beam 2 is incident on the analyzing electromagnet 4, the gap length G which is the y-direction length of the gap 12 of the upper and lower magnetic poles 8 must correspond to the dimension W_{y} in the y direction of the ion beam 2, and hence is very large.

In the gap 12, therefore, the magnetic force lines 16 are largely swollen toward the both outsides in the x direction. The magnetic flux density B in the gap 12 is relatively small in the vicinity of the center 12a between the upper and lower magnetic poles 8 (i.e., of the gap 12), and, as closer to the upper and lower magnetic poles 8 (i.e., as more vertically separated from of the center 12a of the gap 12), the magnetic flux density is relatively larger, so that the magnetic flux density is uneven in the y direction. As the above-mentioned swelling of the magnetic force lines 16 is larger, the degree of the unevenness is larger.

The Lorentz force F which is applied to the ion beam 2 passing through the gap 12 by the magnetic field is indicated by the following expression. In the expression, q is the charge of an ion constituting the ion beam 2, v is the velocity of the ion beam 2 which is constant, and B is the magnetic flux density.
F=qvB [Ex. 1]

As seen also from this expression, when the magnetic flux density B is uneven as described above, also the x-direction Lorentz force Fₓ which is applied to the ion beam 2 passing through the gap is uneven. As indicated in an example shown in FIG. 13, the x-direction Lorentz force Fₓ is unevenly distributed so that it is relatively small in the vicinity of the center 12a of the gap 12, and, as more vertically separated from the center 12a, it is relatively larger.

As a result, even when the ion beam 2 which is straight in the y direction as shown in FIG. 11 is incident on the analyzing electromagnet 4, the shape of the ion beam 2 which is emitted from the analyzing electromagnet 4 is distorted (bent) into an arcuate shape which is similar to the above-described distribution of the x-direction Lorentz force Fₓ as shown in, for example, FIG. 12, or into an arcuate shape which is similar to an L-like shape. FIG. 12 shows the vicinity of the outlet of the analyzing electromagnet 4.

When the shape of the ion beam 2 emitted from the analyzing electromagnet 4 is distorted as described above, various problems arise.

On the downstream side of the analyzing electromagnet 4, for example, an analysis slit which cooperates with the analyzing electromagnet 4 to analyze the momentum of the ion beam 2 is usually disposed. FIG. 14 shows an example of the analysis slit 20. The analysis slit 20 has a linear slit 22. When the ion beam 2 is distorted as described above, therefore, portions 2a, 2b, 2c (the hatched portions) to be cut by the analysis slit 20 are produced, and the amount of the ion beam 2 of a desired ion species passing through the analysis slit 20 is reduced. Since the cut portions are produced, the uniformity of the ion beam 2 is impaired. When the width WS of the slit 22 is increased in order to prevent the beam from being cut, the resolution is lowered.

Furthermore, also the orbit of an unwanted ion species (for example, ¹⁰B⁺) having a momentum similar to that of a desired ion species (for example, ¹¹B⁺) is similarly distorted into an arcuate shape. Therefore, an ion species which cannot originally pass through the slit 22 passes the slit. Also from this point of view, the resolution is lowered.

In addition to the above-described problems in the analysis slit 20, there arises a problem that, when a process such as ion implantation is applied to a target (such as a semiconductor substrate or a glass substrate) with using the ion beam 2 having a shape which is distorted as described above, the uniformity of the process is impaired.

Patent Reference 2 (JP-A-2005-327713 (Paragraphs 0087 to 0089, FIGS. 8 and 9)) below discloses an analyzing electromagnet in which first and second sub-magnetic poles are disposed on the both sides of main magnetic poles that sandwich a ribbon-like ion beam in the longitudinal direction, and the gap lengths of the three kinds of magnetic poles are adjusted, whereby magnetic force lines between the main magnetic poles are made parallel to one another. When the technique is employed, the problem that an ion beam is distorted may be solved. However, there arises another problem that the structure is complicated.

### SUMMARY

Embodiments of the present invention provide an analyzing electromagnet in which such distortion of a ribbon-like ion beam can be reduced by a relatively simple structure.

An analyzing electromagnet according to a first invention is an analyzing electromagnet in which an ion beam having a ribbon-like shape where a dimension in a y direction in a plane intersecting with a traveling direction is larger than a dimension in an x direction perpendicular to the y direction is incident between magnetic poles in which a plan-view shape is curved, and which are opposed to each other through a gap in the y direction, wherein each of the magnetic poles is divided along the traveling direction of the ion beam into three or more odd partial magnetic poles, gaps of odd-numbered partial magnetic pole pairs as counted from an inlet for the ion beam are widened toward an outside of the curvature, and a gap(s) of an even-numbered partial magnetic pole pair(s) as counted from the inlet for the ion beam are widened toward an inside of the curvature.

In the analyzing electromagnet, the gaps of the partial magnetic pole pairs are widened in the manner described above, whereby swelling of magnetic force lines in each of the gaps is made large and the magnetic flux density in each gap is made uneven in the y direction. In a Lorentz force in the x direction which is applied to the ribbon-like ion beam, therefore, a first uneven distribution in which the force in places vertically separated in the y direction from the center of the gap is larger than that in the vicinity of the center is produced.

By contrast, the increase in swelling of the magnetic force lines in each gap causes a second uneven distribution in which the force in the vicinity of the center of the gap is larger than that in places vertically separated from in the y direction the center, to be produced in the x-direction component of the Lorentz force which is applied to the ribbon-like ion beam.

In the gaps of the partial magnetic pole pairs, the ion beam is subjected to both the Lorentz forces of the first and second distributions. The magnitude relationships in the distributions are opposite to each other. When the distributions are combined to each other, therefore, the unevenness of the distribution of the x-direction Lorentz force which is applied to the ribbon-like ion beam can be reduced. Consequently, the above-described distortion of the passing ion beam due to the difference of Lorentz forces acting on the ion beam can be reduced. This action is conducted in each of the partial magnetic pole pairs.

As described above, each of the magnetic poles is divided into three or more odd partial magnetic poles, and the manners of widening the gaps of the partial magnetic pole pairs are alternatingly reversed. Therefore, the divergence or convergence in the y direction of the ion beam emitted from the analyzing electromagnet can be suppressed, and the y-direction dimension of the emitted ion beam can be made close to that of the incident ion beam.

On the contrary to the above, in an analyzing electromagnet according to a second invention, the gaps of the odd-numbered partial magnetic pole pairs as counted from the inlet for the ion beam may be widened toward the inside of the curvature, and the gap(s) of the even-numbered partial magnetic pole pair(s) as counted from the inlet for the ion beam may be widened toward the outside of the curvature.

In an analyzing electromagnet according to a third invention, the gap of at least one of the three or more odd partial magnetic pole pairs may be widened in plural steps.

Preferably, In an analyzing electromagnet according to a fourth invention, the division number of each of the magnetic poles is three.

According to the first and second inventions, the gaps of the partial magnetic pole pairs are widened as described above, whereby the unevenness of the distribution of the x-direction Lorentz force which is applied to the ribbon-like ion beam in the gaps of the partial magnetic pole pairs can be reduced. As a result, distortion of the emitted ribbon-like ion beam can be reduced. Furthermore, this can be realized by a relatively simple structure.

As described above, each of the magnetic poles is divided into three or more odd partial magnetic poles, and the manners of widening the gaps of the partial magnetic pole pairs are alternatingly reversed, whereby the divergence or convergence in the y direction of the ion beam emitted from the analyzing electromagnet can be suppressed, and the y-direction dimension of the emitted ion beam can be made close to that of the incident ion beam. It is possible also to emit an ion beam in which the both dimensions are substantially equal to each other, and which has a high parallelism.

In the first invention, the incident ion beam is first converged by the first partial magnetic pole pair. As compared with the second invention in which the incident ion beam is first diverged by the first partial magnetic pole pair, therefore, the y-direction gap length of the partial magnetic pole pair is not required to be larger than the length corresponding to the y-direction dimension of the incident ion beam. Consequently, there is an advantage that the analyzing electromagnet can be miniaturized.

According to the third invention, in the partial magnetic pole pair in which the gap is widened in plural steps, the distribution of the magnetic field can be adjusted more finely. Consequently, there is a further advantage that the shape of the ion beam can be adjusted more easily.

According to the fourth invention, the division number can be made minimum, and hence the analyzing electromagnet can have the most simplified structure.

Other features and advantages may be apparent from the following detailed description, the accompanying drawings and the claims.

### BRIEF DESCRIPTION OF THE DRAWINGS

FIG. 1 is a plan view showing an embodiment of the analyzing electromagnet of the invention.

FIG. 2 is a schematic sectional view taken along a line A-A or a line C-C of FIG. 1.

FIG. 3 is a schematic sectional view taken along a line B-B of FIG. 1.

FIG. 4 is a view showing a schematic example of the Lorentz force distribution due to unevenness of the magnetic flux density in a gap of a partial magnetic pole pair.

FIG. 5 is a view enlargedly showing one magnetic force line in FIG. 2.

FIG. 6 is a view enlargedly showing one magnetic force line in FIG. 3.

FIG. 7 is a diagram showing an example of a situation in which an ion beam is converged and diverged by three partial magnetic pole pairs shown in FIG. 1, and the three partial magnetic pole pairs are diagrammatically indicated as convex and concave lenses.

FIG. 8 is a diagram showing an example of a situation in which an ion beam is diverged and converged by three partial magnetic pole pairs in another embodiment of the invention, and the three partial magnetic pole pairs are diagrammatically indicated as concave and convex lenses.

FIG. 9 is a diagram showing an example of a situation in which an ion beam is converged and diverged in the case where each of magnetic poles is divided into even partial magnetic poles, and two partial magnetic pole pairs are diagrammatically indicated as convex and concave lenses.

FIG. 10 is a diagram showing another example of a situation in which an ion beam is diverged and converged in the case where each of magnetic poles is divided into even partial magnetic poles, and two partial magnetic pole pairs are diagrammatically indicated as concave and convex lenses.

FIG. 11 is a sectional view showing an example of a related-art analyzing electromagnet, as viewed in the traveling direction of an ion beam, and showing a vicinity of an inlet.

FIG. 12 is a sectional view showing the example of the related-art analyzing electromagnet, as viewed in the traveling direction of the ion beam, and showing a vicinity of an outlet.

FIG. 13 is a view showing a schematic example of the Lorentz force distribution due to unevenness of the magnetic flux density in a gap of magnetic poles shown in FIGS. 11 and 12.

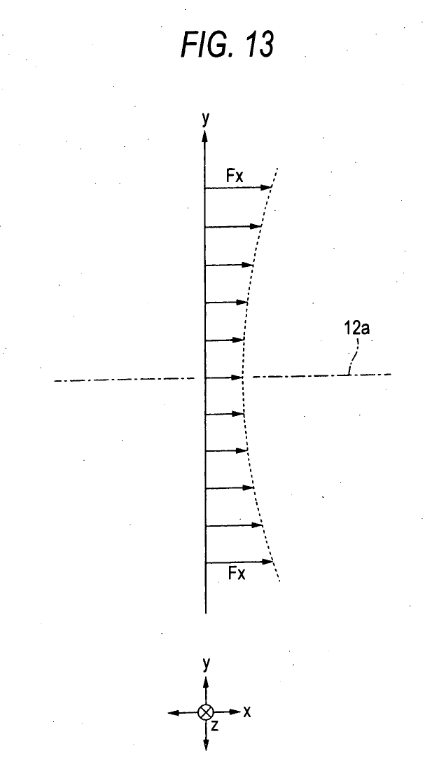

FIG. 14 is a front view showing an example of the case where the ion beam shown in FIG. 12 is incident on an analysis slit, as viewed in the traveling direction of the ion beam.

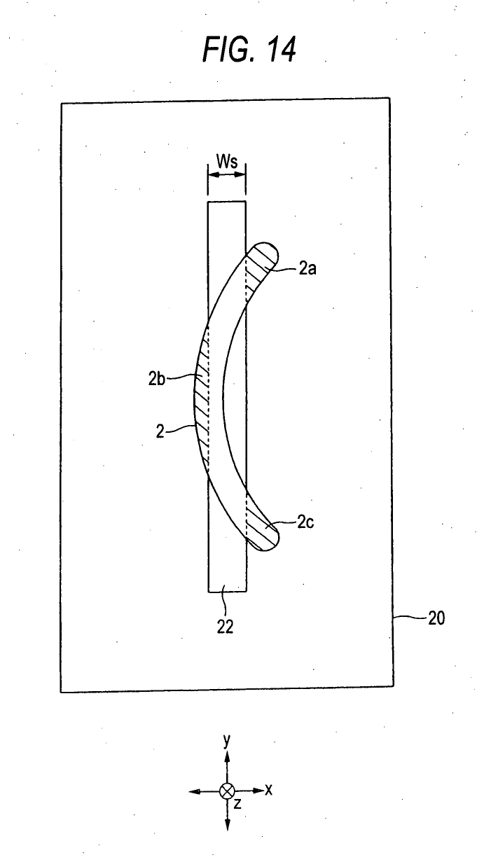

FIG. 15 is a schematic partial perspective view showing an example of a ribbon-like ion beam.

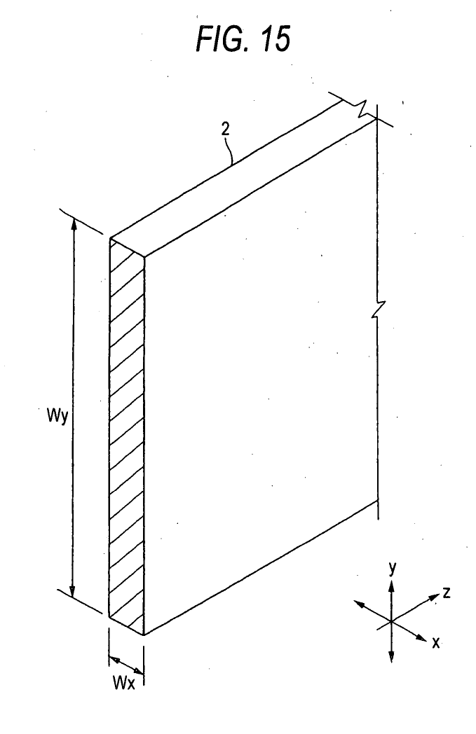

### DETAILED DESCRIPTION

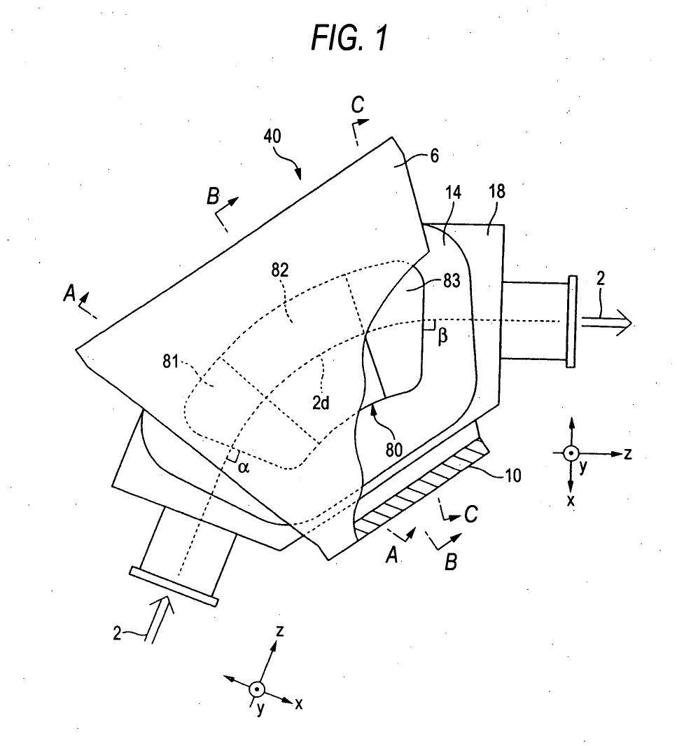

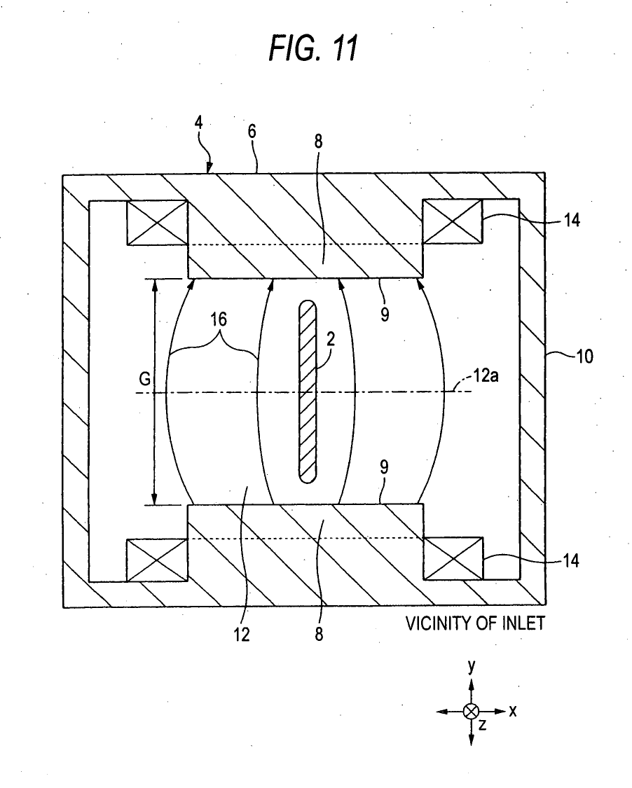

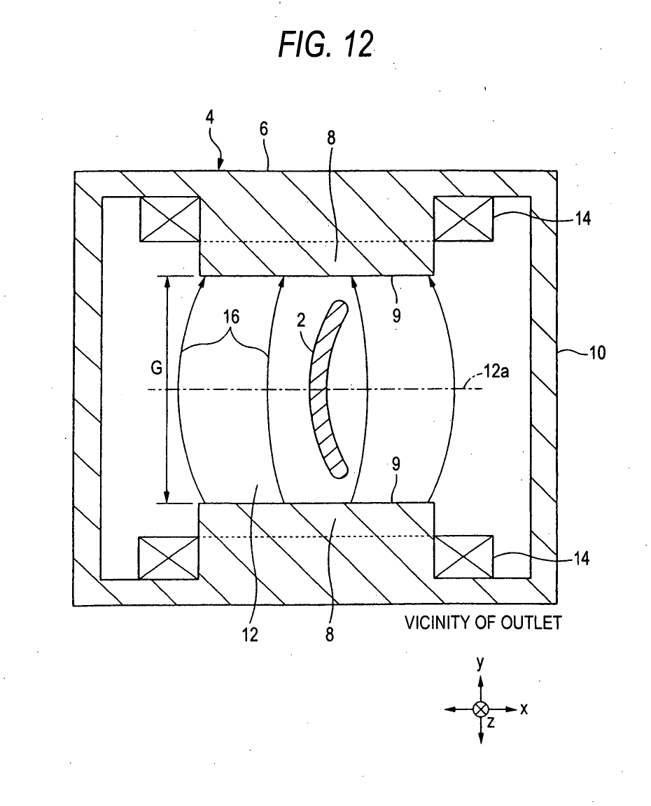

FIG. 1 is a plan view showing an embodiment of the analyzing electromagnet of the invention. The components which are identical with or equivalent to those of the related-art example shown in FIGS. 11 and 12 are denoted by the same reference numerals, and the following description will be made with a focus on points different from the related-art example.

The analyzing electromagnet 40 comprises magnetic poles 80 as substitution for the magnetic poles 8 constituting the related-art analyzing electromagnet 4. The ion beam 2 having the ribbon-like shape which extends in the y direction is incident on a gap of the magnetic poles 80. The plan-view shape of each of the magnetic poles 80 is curved into a sector shape. The center orbit of the ion beam 2 which is to pass through the analyzing electromagnet 40 is denoted by the reference numeral 2d. In the embodiment, both the incident angle α of the ion beam 2 to the magnetic poles 80, and the emission angle β of the ion beam 2 from the magnetic poles 80 are set to be substantially equal to 90 deg.

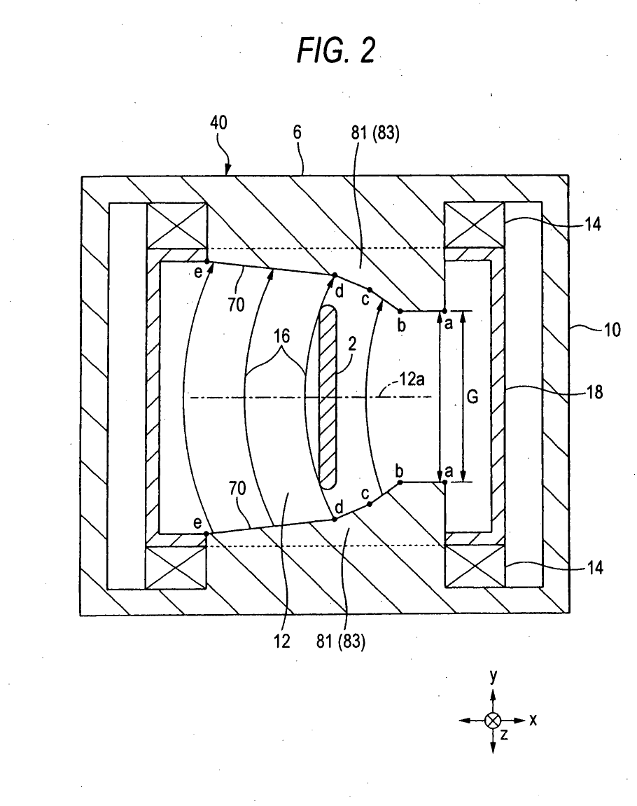

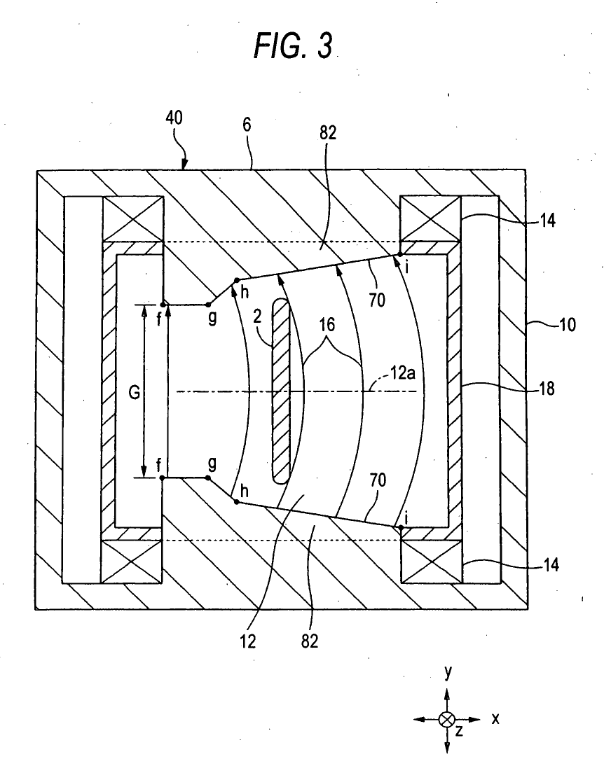

In the embodiment, each of the magnetic poles 80 is divided along the traveling direction z of the ion beam 2 into three partial magnetic poles 81, 82, 83. The coil 14 is collectively wound around the three partial magnetic poles 81 to 83, and common thereto (the same shall apply to other embodiments which will be described later). As shown in FIGS. 2 and 3, each of the partial magnetic pole pairs 81 to 83 consists of a pair of upper and lower partial magnetic poles which are opposed to each other through the gap 12 in the y direction. The ion beam 2 having the ribbon-like shape which extends in the y direction passes the gaps of the partial magnetic pole pairs 81 to 83. The path of the ion beam 2 is surrounded by a vacuum vessel 18 made of a nonmagnetic material, and maintained to a vacuum atmosphere.

As shown in FIG. 2, the gaps 12 of the odd-numbered partial magnetic pole pairs as counted from an inlet for the ion beam 2, i.e., in the embodiment, the first and third partial magnetic pole pairs 81, 83 are widened toward the outside (the left side of FIG. 2) of the curvature (that is, the radius of curvature) of the sector shape. In other words, in the gap length G in the y direction of the gaps 12, the outside of the curvature is gradually increased than the inside. In the embodiment, the gaps of the partial magnetic pole pairs 81, 83 have the same shape, and hence they are shown in the same FIG. 2.

More specifically, in the embodiment, each of the gaps 12 of the partial magnetic pole pairs 81, 83 is widened in three steps. Namely, the upper and lower opposing faces 70 of the partial magnetic pole pairs 81, 83 are formed so as to be parallel in the x direction with each other in a range from the inner end a to a place b which is slightly outward separated therefrom, vertically inclined in a large degree in the y direction in a range from the place b to a place c which is slightly outward separated therefrom, vertically inclined in a medium degree in the y direction in a range from the place c to a place d which is slightly outward separated therefrom, and vertically inclined in a small degree in the y direction in a range from the place d to the outer end e. The upper and lower opposing faces 70 have a shape which is axisymmetric about the center 12a of the gap 12.

By contrast, as shown in FIG. 3, the gap 12 of the even-numbered partial magnetic pole pair as counted from the inlet for the ion beam 2, i.e., in the embodiment, the second partial magnetic pole pair 82 is widened toward the inside (the right side of FIG. 3) of the curvature of the sector shape. In other words, in the gap length G in the y direction of the gap 12, the inside of the curvature is gradually increased than the outside.

More specifically, in the embodiment, the gap 12 of the partial magnetic pole pair 82 is widened in two steps. Namely, the upper and lower opposing faces 70 of the partial magnetic pole pair 82 are formed so as to be substantially parallel in the x direction with each other in a range from the outer end f to a place g which is slightly inward separated therefrom, vertically inclined in a large degree in the y direction in a range from the place g to a place h which is slightly inward separated therefrom, and vertically inclined in a small degree in the y direction in a range from the place h to the inner end i. The upper and lower opposing faces 70 have a shape which is axisymmetric about the center 12a of the gap 12.

Each of the partial magnetic pole pairs 81 to 83 may be configured by (a) magnetic poles around which the coil 14 is wound, and in which inner side faces of the y direction extend in the x direction (for example, they are substantially parallel with each other), and (b) one or more magnetic pole pieces which are attached to the inner side of the y direction of each of the magnetic poles, and in which the opposing faces 70 are widened in the manner described above to form the gap 12 that is widened in the manner described above (the same shall apply to the other embodiments which will be described later), because of the following reason. Even when the partial magnetic pole pairs are configured as described above, they function in a substantially same manner as a magnetic circuit.

Since the gaps 12 of the partial magnetic pole pairs 81, 83 are widened in the manner described above, the outward swelling of the magnetic force lines 16 in each of the gaps 12 is made large as shown in FIG. 2. Therefore, the magnetic flux density B in each of the gaps 12 is relatively small in the vicinity of the center 12a of the gap 12, and, as more vertically separated from of the center 12a, the magnetic flux density is relatively larger, so that the magnetic flux density B is uneven in the y direction.

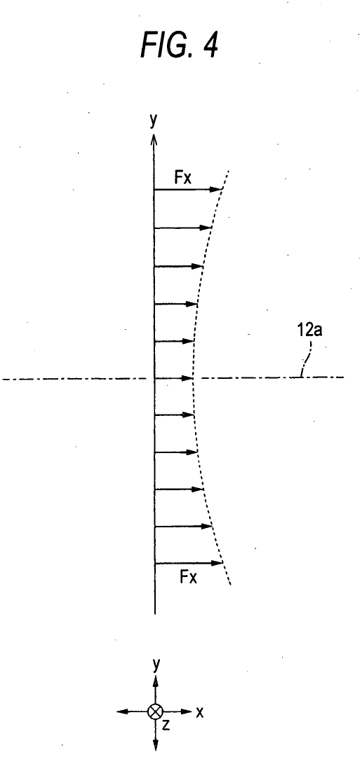

Because of the uneveness of the magnetic flux density B, as shown in an example of FIG. 4, a first uneven distribution in which the force in places vertically separated in the y direction from the center 12a of each of the gaps 12 of the partial magnetic pole pairs 81, 83 is larger than that in the vicinity of the center is produced in a Lorentz force Fₓ in the x direction which is applied to the ion beam 2 passing through the gap 12.

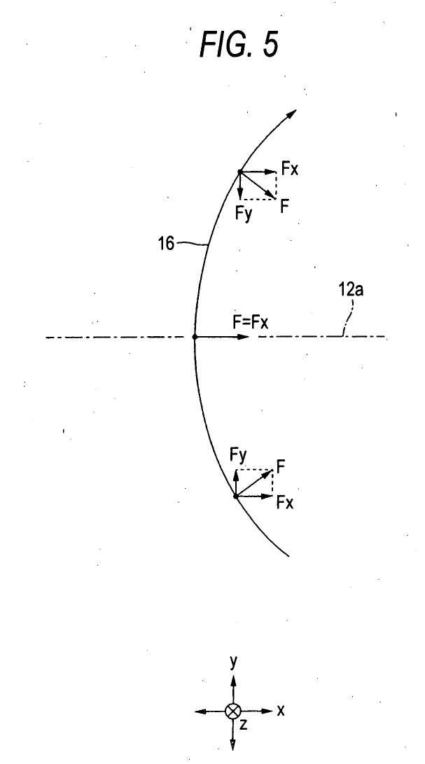

By contrast, because of the enlargement of the outward swelling of the magnetic force lines 16 in the gaps 12 of the partial magnetic pole pairs 81, 83, as shown in FIG. 5, a second uneven distribution in which the force in the vicinity of the center 12a of each of the gaps 12 is larger than that in places vertically separated from the center in the y direction is produced in the x-direction component Fₓ of the Lorentz force F which is applied to the ribbon-like ion beam.

The ion beam 2 is subjected to both the Lorentz forces Fₓ of the first and second distributions, in the gaps 12 of the partial magnetic pole pairs 81, 83. The magnitude relationships in the distributions are opposite to each other. When the distributions are combined to each other, therefore, the unevenness in the y direction of the distribution of the x-direction Lorentz force Fₓ which is applied to the ribbon-like ion beam 2 can be reduced. Consequently, the above-described arcuate distortion of the passing ion beam 2 due to the difference of Lorentz forces acting on the ion beam 2 can be reduced. This action is conducted in each of the partial magnetic pole pairs 81, 83.

Also in the partial magnetic pole pair 82, since the gap 12 is widened in the above-described manner, the inward swelling of the magnetic force lines 16 in the gap 12 is made large as shown in FIG. 3. Therefore, the magnetic flux density B in the gap 12 is relatively small in the vicinity of the center 12a of the gap 12, and, as more vertically separated from of the center 12a, the magnetic flux density B is relatively larger, so that the magnetic flux density is uneven in the y direction.

Because of the unevenness of the magnetic flux density B, in the same manner as in the example shown in FIG. 4, a first uneven distribution in which the force in places vertically separated in the y direction from the center 12a of the gap 12 of the partial magnetic pole pair 82 is larger than that in the vicinity of the center is produced in a Lorentz force Fₓ in the x direction which is applied to the ion beam 2 passing through the gap 12.

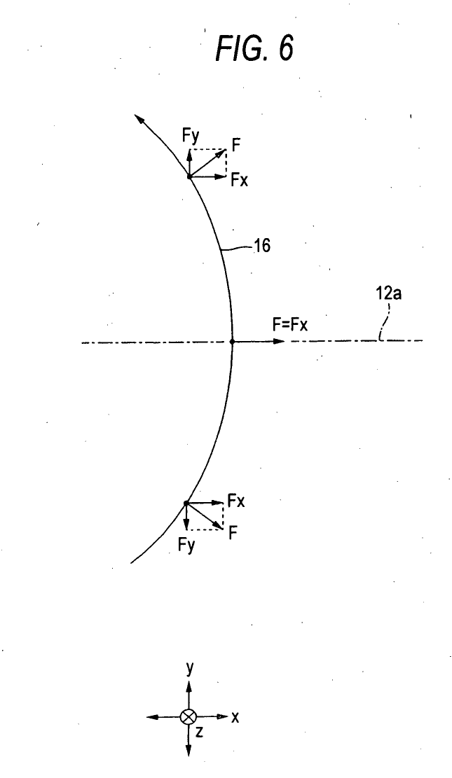

By contrast, because of the enlargement of the inward swelling of the magnetic force lines 16 in the gap 12 of the partial magnetic pole pair 82, as shown in FIG. 6, a second uneven distribution in which the force in the vicinity of the center 12a of the gap 12 is larger than that in places vertically separated from the center in the y direction is produced in the x-direction component Fₓ of the Lorentz force F which is applied to the ribbon-like ion beam.

The ion beam 2 is subjected to both the Lorentz forces Fₓ of the first and second distributions, in the gap 12 of the partial magnetic pole pair 82. The magnitude relationships in the distributions are opposite to each other. When the distributions are combined to each other, therefore, the unevenness in the y direction of the distribution of the x-direction Lorentz force Fₓ which is applied to the ribbon-like ion beam 2 can be reduced. Consequently, the above-described arcuate distortion of the passing ion beam 2 due to the difference of the Lorentz forces acting on the ion beam 2 can be reduced. This action is conducted in the partial magnetic pole pair 82.

According to the analyzing electromagnet 40, in the partial magnetic pole pairs 81 to 83, as described above, the above-described distortion of the ion beam 2 due to the difference of the Lorentz forces Fₓ acting on the ion beam 2 passing through the partial magnetic pole pairs can be reduced. This action can be adjusted by, for example, the manner of widening the gaps 12 of the partial magnetic pole pairs 81 to 83, and the lengths of the partial magnetic pole pairs 81 to 83 in the traveling direction z of the ion beam (the same shall apply to the other embodiments such as an analyzing electromagnet 40a which will be described later). As a result, the above-described distortion of the ion beam 2 emitted from the analyzing electromagnet 40 is reduced, and the ion beam 2 which is approximately straight can be emitted.

Therefore, the above-discussed problems due to distortion of the shape of the ion beam 2 can be prevented from occurring. Namely, the amount of a desired ion species can be increased, and the resolution can be enhanced. Furthermore, the uniformity of a target process can be improved.

Moreover, the above-described structure of the magnetic poles 80 is simpler than the magnetic-pole structure disclosed in Patent Reference 2. Therefore, the above-described distortion of the ribbon-like ion beam 2 can be reduced by a relatively simple structure.

Next, the convergence and divergence in the y direction of the ion beam 2 in each of the partial magnetic pole pairs 81 to 83 will be described.

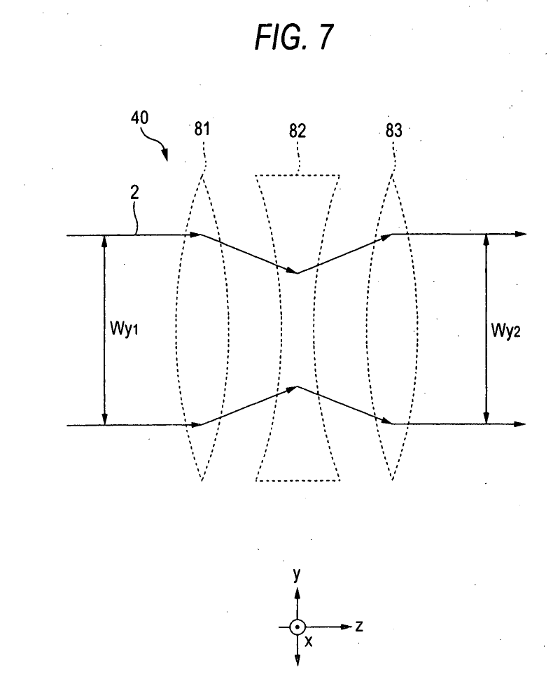

As shown in FIG. 5, in the each of the gaps 12 of the partial magnetic pole pairs 81, 83, the y-direction component F_{y} of the Lorentz force F which is applied to the ion beam 2 is directed toward the center 12a of the gap 12, and hence the ion beam 2 is subjected to a converging force in the y direction. Namely, the partial magnetic pole pairs 81, 83 exert a function of converging the ion beam 2 in the y direction. In FIG. 7, the partial magnetic pole pairs 81, 83 are diagrammatically indicated as convex lenses.

By contrast, as shown in FIG. 6, in the gap 12 of the partial magnetic pole pair 82, the y-direction component F_{y} of the Lorentz force F which is applied to the ion beam 2 is directed toward the side opposite to the center 12a of the gap 12, and hence the ion beam 2 is subjected to a diverging force in the y direction. Namely, the partial magnetic pole pair 82 exerts a function of diverging the ion beam 2 in the y direction. In FIG. 7, the partial magnetic pole pair 82 is diagrammatically indicated as a concave lens.

When the gaps 12 of the partial magnetic pole pairs 81 to 83 are widened as described above, therefore, the above-described arcuate distortion of the passing ion beam 2 due to the difference of the Lorentz forces acting on the ion beam 2 can be reduced. At the same time, the ion beam 2 is subjected to a converging or diverging force in the y direction.

In the analyzing electromagnet 40, however, each of the magnetic poles 80 is divided into three partial magnetic poles as described above, and the manners of widening the gaps of the partial magnetic pole pairs 81 to 83 are alternatingly reversed. As shown in FIG. 7, therefore, the incident ion beam 2 can be first converged by the first partial magnetic pole pair 81, then diverged by the second partial magnetic pole pair 82, and further converged by the third partial magnetic pole pair 83. As a result, the divergence or convergence in the y direction of the ion beam 2 emitted from the analyzing electromagnet 40 can be suppressed, and the y-direction dimension W_{y2} of the emitted ion beam 2 can be made close to the y-direction dimension W_{y1} of the incident ion beam 2. This action can be adjusted by, for example, the manner of widening the gaps 12 of the partial magnetic pole pairs 81 to 83, and the lengths of the partial magnetic pole pairs 81 to 83 in the traveling direction z of the ion beam (the same shall apply to the other embodiments such as the analyzing electromagnet 40a which will be described later). As a result, it is possible also to emit the ion beam 2 in which the dimensions W_{y1} and W_{y2} are substantially equal to each other, and which has a high parallelism.

In each of the partial magnetic pole pairs 81 to 83, the ion beam 2 can be converged or diverged with using the swelling of the magnetic force lines 16 of the gap 12. In the analyzing electromagnet 40, therefore, it is possible not to use the edge focus caused by setting the incident angle α and the emission angle β to an angle other than 90 deg. In the analyzing electromagnet 40, consequently, both the incident angle α and the emission angle β are set to be substantially equal to 90 deg. The same shall apply to the analyzing electromagnet 40a which will be described later.

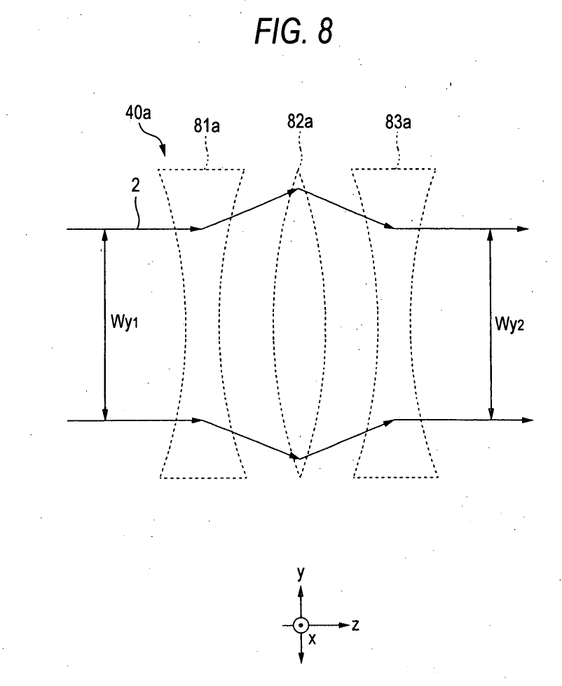

The sequence of the manners of widening the gaps 12 of the partial magnetic pole pairs which are obtained by dividing each of the magnetic poles 80 into three or more odd pieces may be reversed. This will be described with reference to an example in which the division number is three. The gaps 12 of the odd-numbered partial magnetic pole pairs as counted from the inlet for the ion beam 2, i.e., the first and third partial magnetic pole pairs are widened toward the inside of the curvature. The partial magnetic pole pairs are indicated by the reference numerals 81a and 83a. For example, the partial magnetic pole pairs 81a, 83a have the same structure as the partial magnetic pole pair 82 shown in FIG. 3. Because of the same function as the partial magnetic pole pair 82, therefore, the partial magnetic pole pairs 81a, 83a exert the function of diverging the ion beam 2 in the y direction, as diagrammatically indicated as concave lenses in FIG. 8.

By contrast, the gap 12 of the even-numbered partial magnetic pole pair as counted from the inlet for the ion beam 2, i.e., the second partial magnetic pole pair is widened toward the outside of the curvature. The partial magnetic pole pair is indicated by the reference numeral 82a. For example, the partial magnetic pole pair 82a has the same structure as the partial magnetic pole pair 81 or 83. Because of the same function as the partial magnetic pole pair 81 or 83, therefore, the partial magnetic pole pair 82a exerts the function of converging the ion beam in the y direction, as diagrammatically indicated as a convex lens in FIG. 8.

The analyzing electromagnet 40a shown in FIG. 8 having the partial magnetic pole pairs 81a to 83a can attain the function and effect which are approximately identical with those of the analyzing electromagnet 40.

Namely, the incident ion beam 2 can be first diverged by the first partial magnetic pole pair 81a, then converged by the second partial magnetic pole pair 82a, and further diverged by the third partial magnetic pole pair 83a. As a result, the divergence or convergence in the y direction of the ion beam 2 emitted from the analyzing electromagnet 40a can be suppressed, and the y-direction dimension W_{y2} of the emitted ion beam 2 can be made close to the y-direction dimension W_{y1} of the incident ion beam 2. As a result, it is possible also to emit the ion beam 2 in which the dimensions W_{y1} and W_{y2} are substantially equal to each other, and which has a high parallelism.

In the partial magnetic pole pairs 81a to 83a, by the same function as the partial magnetic pole pairs 81 to 83, the above-described arcuate distortion of the ion beam 2 due to the difference of the Lorentz forces acting on the passing ion beam 2 can be reduced. As a result, the above-described distortion of the ion beam 2 emitted from the analyzing electromagnet 40a is reduced, and the ion beam which is approximately straight can be emitted.

The difference in function and effect between the analyzing electromagnets 40, 40a will be described. In the analyzing electromagnet 40, as shown in FIG. 7, the incident ion beam 2 is first converged by the first partial magnetic pole pair 81. By contrast, in the analyzing electromagnet 40a, as shown in FIG. 8, the incident ion beam 2 is first diverged by the first partial magnetic pole pair 81a. In the case of the analyzing electromagnet 40a, therefore, the gap length G in the y direction of the partial magnetic pole pair 82a or the like must be larger than the length corresponding to the y-direction dimension W_{y1} of the incident ion beam 2. In the case of the analyzing electromagnet 40, in contrast, the length is not required to be set in this manner. Consequently, the analyzing electromagnet 40 can be further miniaturized as compared with the analyzing electromagnet 40a.

The functions that the divergence or convergence in the y direction of the emitted ion beam 2 can be suppressed, and that the y-direction dimension W_{y2} of the emitted ion beam 2 can be made close to the y-direction dimension W_{y1} of the incident ion beam 2 cannot be attained by a configuration other than that in which each of the magnetic poles 80 is divided into three or more odd pieces and the manner of widening the gaps of the partial magnetic pole pairs are alternatingly reversed as described above.

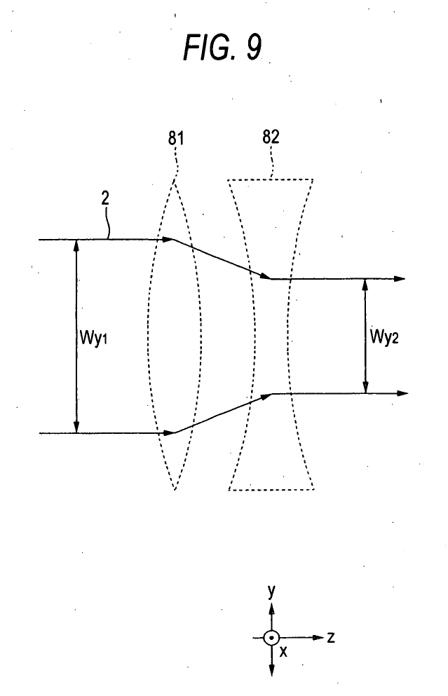

In the case where each of the magnetic poles 80 is divided into even pieces or, for example, two pieces or the partial magnetic pole pairs 81, 82 as shown in FIG. 9, for example, the divergence or convergence of the ion beam 2 emitted from the partial magnetic pole pair 82 can be suppressed, but the y-direction dimension W_{y2} of the emitted ion beam 2 is smaller than the y-direction dimension W_{y1} of the incident ion beam 2. According to the configuration, for example, there arises problems such as that (a) the beam current density of the emitted ion beam 2 is larger than that of the incident ion beam 2, and (b) the whole surface of a target in which the y-direction dimension W_{y1} of the incident ion beam 2 is assumed cannot be irradiated with the ion beam. Also in the case where the division number is an even number of four or more, similar problems are produced.

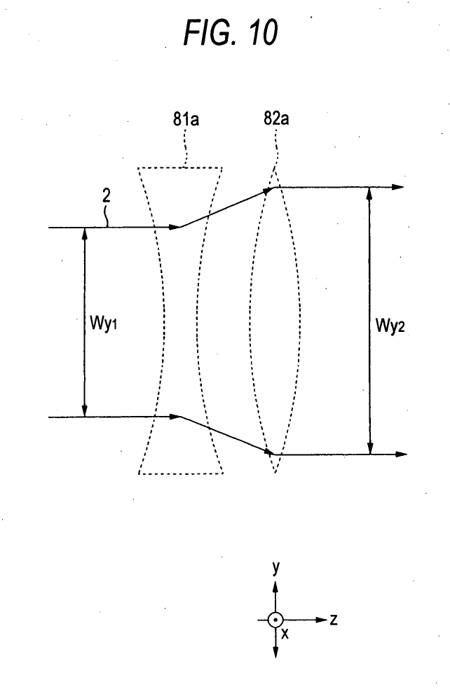

In the case of two pieces or the partial magnetic pole pairs 81a, 82a as shown in FIG. 10, for example, the divergence or convergence of the ion beam 2 emitted from the partial magnetic pole pair 82a can be suppressed, but the y-direction dimension W_{y2} of the emitted ion beam 2 is larger than the y-direction dimension W_{y1} of the incident ion beam 2. According to the configuration, for example, there arise problems such as that (a) the beam current density of the emitted ion beam 2 is smaller than that of the incident ion beam 2, and (b) the dimension of the beam line must be reduced in order to prevent collision of the emitted ion beam 2 from occurring. Also in the case where the division number is an even number of four or more, similar problems are produced.

The case where the division number is odd and one (this is identical with the case where the magnetic poles 80 are not divided) is identical with the case shown in FIG. 9 where only the partial magnetic pole pair 81 is disposed, or that shown in FIG. 10 where only the partial magnetic pole pair 81a is disposed, and the emitted ion beam 2 is converged or diverged. In any case, there arise problems such as that it is difficult to normally transport the ion beam 2.

For the above reasons, it is not preferable to set the division number of each of the magnetic poles 80 to one or an even number.

The division number of each of the magnetic poles 80 may be set to an odd number of five or more. This case is identical with the case where, for example, plural sets of partial magnetic pole pairs 82, 83 shown in FIG. 7 are repeatedly disposed. In such a case, it is possible to attain the same effects as those of the analyzing electromagnet 40. Alternatively, this case is identical with the case where plural sets of partial magnetic pole pairs 82a, 83a shown in FIG. 8 are repeatedly disposed. Also in such a case, it is possible to attain the same effects as those of the analyzing electromagnet 40a.

However, the case where the division number of each of the magnetic poles 80 is three can attain the above-mentioned effects while the division number is smallest. In this case, therefore, the analyzing electromagnet 40 or 40a can be structured in the simplest manner.

When the gap 12 of each of the partial magnetic pole pairs 81 to 83 of the analyzing electromagnet 40 is widened in plural steps as shown in, for example, the embodiment, the distribution of the magnetic field can be adjusted more finely. Consequently, the shape of the ion beam 2 can be adjusted more easily. Instead of the configuration where all of the partial magnetic pole pairs 81 to 83 are structured as described above, a configuration where at least one of the partial magnetic pole pairs is structured as described above may be employed. Also in this configuration, it is possible to attain the above-mentioned effects. However, the configuration where all of the partial magnetic pole pairs 81 to 83 are structured as described above is preferable because more partial magnetic pole pairs can attain the effects. The above is applicable also to the partial magnetic pole pairs 81a to 83a which have been described with reference to FIG. 8, and which constitute the analyzing electromagnet 40.

In stead of the configuration where the gap 12 of each partial magnetic pole pair is widened in plural steps, that where the gap is widened in a linear manner, in a curved manner which is convex toward the center 12a, or in a curved manner which is concave toward the center 12a may be employed. In plural partial magnetic pole pairs, these shapes may be combinedly employed.

In odd-numbered partial magnetic pole pairs as counted from the inlet for the ion beam 2, gaps 12 of the same shape may be employed, or gaps 12 of different shapes may be employed. The above is applicable also to even-numbered partial magnetic pole pairs as counted from the inlet for the ion beam 2.

The core 6 may have a C-like section shape.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An analyzing electromagnet for performing momentum analysis of an ion beam having a ribbon-like shape where a dimension in a y direction in a plane intersecting with a traveling direction is larger than a dimension in an x direction perpendicular to the y direction, said analyzing electromagnet comprising:
magnetic poles, in which a plan-view shape is curved, which are opposed to each other through a gap in the y direction, and between which the ion beam is incident,
wherein each of said magnetic poles is divided along the traveling direction of the ion beam into three or more odd partial magnetic poles, gaps of odd-numbered partial magnetic pole pairs as counted from an inlet for the ion beam are widened toward an outside of the curvature, and a respective gap corresponding to each of at lease one even-numbered partial magnetic pole pair as counted from said inlet for the ion beam is widened toward an inside of the curvature.

2. An analyzing electromagnet for performing momentum analysis of an ion beam having a ribbon-like shape where a dimension in a y direction in a plane intersecting with a traveling direction is larger than a dimension in an x direction perpendicular to the y direction, said analyzing electromagnet comprising:
magnetic poles, in which a plan-view shape is curved, which are opposed to each other through a gap in the y direction, and between which the ion beam is incident,
wherein each of said magnetic poles is divided along the traveling direction of the ion beam into three or more odd partial magnetic poles, gaps of odd-numbered partial magnetic pole pairs as counted from an inlet for the ion beam are widened toward an inside of the curvature, and a respective gap corresponding to each of at least one even-numbered partial magnetic pole pair as counted from said inlet for the ion beam is widened toward an outside of the curvature.

3. An analyzing electromagnet according to claim 1, wherein a gap of at least one of said three or more odd partial magnetic pole pairs is widened in plural steps.

4. An analyzing electromagnet according to claim 2, wherein a gap of at least one of said three or more odd partial magnetic pole pairs is widened in plural steps.

5. An analyzing electromagnet according to claim 1, wherein a division number of each of said magnetic poles is three.

6. An analyzing electromagnet according to claim 2, wherein a division number of each of said magnetic poles is three.

7. An analyzing electromagnet according to claim 5, wherein the gaps of odd-numbered partial magnetic pole pairs as counted from an inlet for the ion beam are widened toward an outside of the curvature, and a gap of an even-numbered partial magnetic pole pair as counted from said inlet for the ion beam is widened toward an inside of the curvature.

8. An analyzing electromagnet according to claim 6, wherein the gaps of odd-numbered partial magnetic pole pairs as counted from an inlet for the ion beam are widened toward an inside of the curvature, and a gap of an even-numbered partial magnetic pole pair as counted from said inlet for the ion beam is widened toward an outside of the curvature.

9. An analyzing electromagnet according to claim 1, wherein a division number of each of said magnetic poles is five or more odd number, and the gaps of odd-numbered partial magnetic pole pairs as counted from an inlet for the ion beam are widened toward an outside of the curvature, and gaps of even-numbered partial magnetic pole pairs as counted from said inlet for the ion beam are widened toward an inside of the curvature.

10. An analyzing electromagnet according to claim 2, wherein a division number of each of said magnetic poles is five or more odd number, the gaps of odd-numbered partial magnetic pole pairs as counted from an inlet for the ion beam are widened toward an inside of the curvature, and gaps of even-numbered partial magnetic pole pairs as counted from said inlet for the ion beam are widened toward an outside of the curvature.
